(19) United States
(12) Patent Application Publication
(10) Pub. No.: US 2015/0076305 A1
(43) Pub. Date: Mar. 19, 2015

(54) REMOVABLE CORNER GUARD FOR CONTROL TABLES OR TOOL BOXES

(71) Applicant: WILLIAM FRICK & COMPANY, LIBERTYVILLE, IL (US)

(72) Inventors: Jeffrey H. Brandt, Libertyville, IL (US); Chad E. Svastisalee, Chicago, IL (US); Suraj Prakash, Hainsville, IL (US)

(73) Assignee: WILLIAM FRICK & COMPANY, LIBERTYVILLE, IL (US)

(21) Appl. No.: 14/491,089

(22) Filed: Sep. 19, 2014

Related U.S. Application Data
(60) Provisional application No. 61/879,734, filed on Sep. 19, 2013.

(51) Int. Cl. B25H 3/02; A47B 95/04; A47B 96/00

(52) U.S. Cl. CPC B25H 3/02; A47B 96/00; A47B 95/043
USPC 248/345.1

(57) ABSTRACT

A removable corner guard is provided. The removable corner guard is especially suitable for protecting the corners of, for example, control tables or tool boxes from deformations and from scratches. Further, the corner guard may be used as decorative addition to an otherwise plain control table or tool box. The device has a semi-rigid rubber housing which covers securing anchors having an internal skeleton. An extended ridge on a lower end of the corner guard locks the corner guard at the lower end of the edge of the control table. The corner guard may be adjusted to fit control tables or tool boxes of various sizes. A non-slip textured exterior surface may allow for the device to be easily transported.

### CROSS REFERENCE TO RELATED APPLICATIONS

The following application is based on and claims the priority benefit of U.S. provisional application Ser. No.:61/879,734 filed Sep. 19, 2013 currently co-pending; the entire contents of which are incorporated by reference.

### BACKGROUND OF THE INVENTION

A removable corner guard is provided. The removable corner guard is especially suitable for protecting the corners of, for example, control tables or tool boxes from deformations and from scratches. Further, the corner guard may be used as decorative addition to an otherwise plain control table or tool box. The device has a semi-rigid rubber housing which covers securing anchors having an internal skeleton. An extended ridge on a lower end of the corner guard locks the corner guard at the lower end of the edge of the control table. The corner guard may be adjusted to fit control tables or tool boxes of various sizes. The extended ridge of the lower end may first be secured to the lower end of the control table or tool box and then the top end of the corner guard may rest on the top end of the control table or tool box by a tab. A non-slip textured exterior surface may allow for the device to be easily transported.

Over the years, attempts have been made to provide guards for corners of structures. For example, U.S. Pat. No.: 8,371,081 to Bennett et al. discloses a wall guard for use around wall corners in which the wall guard has a pair of retainers which are flexibly mounted to one another. The retainers are coupled to one another by way of an adhesive tape material that extends over the back sides of the retainers. A cover is secured to the pair of retainers for absorbing impacts from passing traffic to thereby protect the corner of the wall against wear and tear.

Further, U.S. Pat. No.: 7,587,79 to McCue discloses a wall guard for use around wall corners in which the wall guard has a pair of retainers that are flexibly mounted to one another. The retainers are coupled to one another by way of an adhesive tape material that extends over the back sides of the retainers. A cover is secured to the pair of retainers for absorbing impacts from passing traffic to thereby protect the corner of the wall against wear and tear.

Still further, U.S. Pat. No.: 6,125,488 to Vogland discloses a corner guard configured to attach to and protect the corner of a mattress foundation, as well as to receive selected ornamentation. The corner guard includes an impact-resistant core and a cover that overlies at least at portion of the core. In one embodiment of the invention, the cover is constructed of fabric and may be ornamented with patterns or indicia by a variety of techniques. The cover ensures that the ornamentation will not be damaged even if the corner guard must be bent to match the shape of the mattress foundation. Optionally, a foam layer may be positioned between the core and the cover to impart a quilted texture and appearance to the corner guard, and to provide additional padding for the mattress foundation.

However, these patents fail to describe a corner guard for a control table or tool box which is easy to use and efficient as is described in the present application. Further, these patents fail to provide a corner guard which has an internal skeleton for securing an anchor to a control table.

### SUMMARY OF THE INVENTION

A removable corner guard is provided. The removable corner guard is especially suitable for protecting the corners of, for example, control tables or tool boxes from deformations and from scratches. Further, the corner guard may be used as decorative addition to an otherwise plain control table or tool box. The device has a semi-rigid rubber housing which covers securing anchors having an internal skeleton. An extended ridge on a lower end of the corner guard locks the corner guard at the lower end of the edge of the control table. The corner guard may be adjusted to fit control tables or tool boxes of various sizes. The extended ridge of the lower end may first be secured to the lower end of the control table or tool box and then the top end of the corner guard may rest on the top end of the control table or tool box by a tab. A non-slip textured exterior surface may allow for the device to be easily transported.

An advantage of the present corner guard is that the present corner guard may have various durometer measurements so as to provide a guard of various stiffness levels.

A further advantage of the present corner guard is that the present corner guard may have various indicia (or artwork) located on a main body section to illustrate a logo or other desired illustration or information.

Yet another advantage of the present corner guard is that the present corner guard may protect a control table or tool box.

And another advantage of the present corner guard is that the present corner guard may have a non-slip textured exterior surface to prevent slippage.

Still another advantage of the present corner guard is that the present corner guard may have a tab portion which is partially inserted within a main body section wherein the tab portion has extensions which may accommodate increased tension forces.

And another advantage of the present corner guard is that the present corner guard may be reused on various control tables.

Still another advantage of the present corner guard is that the present corner guard may be placed on or removed from a control table or tool box very quickly.

For a more complete understanding of the above listed features and advantages of the present corner guard reference should be made to the detailed description and the drawings. Further, additional features and advantages of the invention are described in, and will be apparent from, the detailed description of the preferred embodiments.

### BRIEF DESCRIPTION OF THE DRAWINGS

FIG. 1 illustrates a perspective view of the corner guard.

FIG. 2 illustrates a top view of the corner guard wherein the tabs are removed.

FIG. 3 illustrates a top view of the corner guard with the tabs secured.

FIG. 4 illustrates a back view of the corner guard.

FIG. 5A illustrates a detailed view of the top of the corner guard without a tab.

FIG. 5B illustrates a side view of the removable cap of the bottom of the corner guard.

FIG. 6 illustrates a front view of the corner guard wherein the tab portion is illustrated in phantom partially within the main body portion of the corner guard.

FIG. 7 illustrates a cross-sectional view of the center of the corner guard.

FIG. 8 illustrates an outline of the tab portion of the corner guard.

FIG. 9A illustrates a side view of the tab portion of the corner guard.

FIG. 9B illustrates a side cross sectional view of the corner guard secured to a control table edge.

FIG. 10 illustrates a perspective view of the corner guard tab.

FIG. 11 illustrates a perspective view of the corner guard wherein the tensional forces are illustrated.

FIG. 12 illustrates a perspective view of the corner guard installed on a control table or tool box.

FIG. 13 illustrates a top perspective view of the corner guard installed on a control table or tool box.

FIG. 14 illustrates a side front view of the corner guard having indicia or another illustration printed thereon.

FIG. 15 illustrates a view of the corner guard wherein the removable cap is secured on the bottom of the main body.

### DETAILED DESCRIPTION OF THE PREFERRED EMBODIMENTS

A removable corner guard is provided. The removable corner guard is especially suitable for protecting the corners of, for example, control tables or tool boxes from deformations and from scratches. Further, the corner guard may be used as decorative addition to an otherwise plain control table or tool box. The device has a semi-rigid rubber housing which covers securing anchors having an internal skeleton. An extended ridge on a lower end of the corner guard locks the corner guard at the lower end of the edge of the control table. The corner guard may be adjusted to fit control tables or tool boxes of various sizes. The extended ridge of the lower end may first be secured to the lower end of the control table or tool box and then the top end of the corner guard may rest on the top end of the control table or tool box by a tab. A non-slip textured exterior surface may allow for the device to be easily transported.

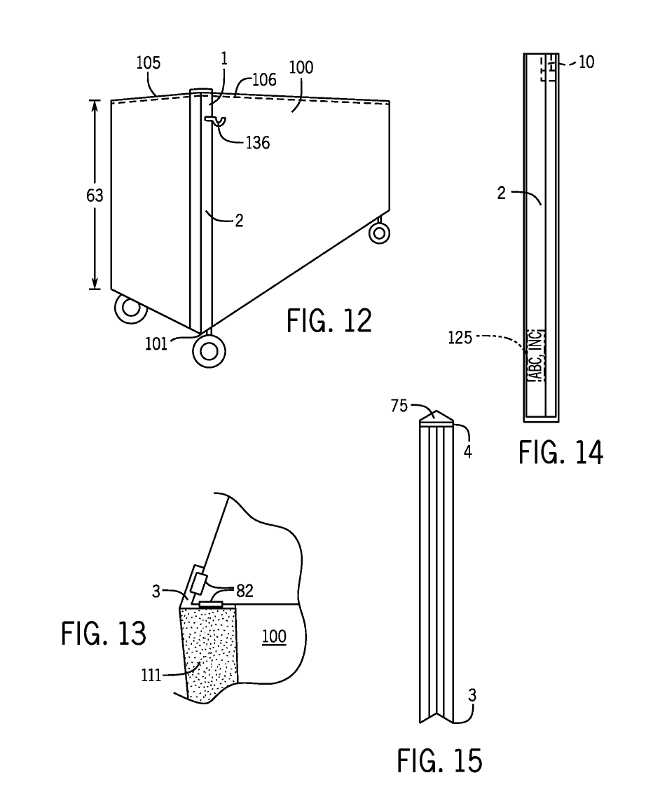

Referring now to the drawings, a corner guard 1 for a control table 100 (FIG. 12) is provided. Preferably, a corner guard 1 is used for each corner of a control table or tool box 100. In an embodiment, the corner guard 1 may be generally constructed of rubber and metal and in an embodiment, the corner guard 1 may have a glow-in-the-dark or fluorescent paint exterior to increase visibility in diminished lighting. In particular, the device 1 may be constructed of a specialized rubber (such as polychloroprene or neoprene) with a specific durometer to suit a particular stiffness needed for a specific control table 100 (or tool box); the higher the durometer resulting in the higher the stiffness. In particular, the greater stiffness the better the corner guard 1 will fit snugly on the control table 100. It should be understood that the device 1 may be constructed of any suitable material. In an embodiment, the corner guard 1 may have indicia (or art) 125 (FIG. 14) on the exterior surface of the body 2. As illustrated in 7, the corner guard 1 may be generally “L-shaped” so that the device 1 may be snugly placed over a corner of the control table 100.

In an embodiment, the corner guard 1 may have a plurality of small bumps 111 (FIG. 13) creating a generally rough textured exterior surface. In an alternative embodiment, a plurality of small bumps 111 may also be present on the interior surface of the corner guard (See FIG. 5B). The plurality of small bumps 111 may reduce the chances of the device 1 (and the attached control table 100) from slipping during use of the control table 100 or during transportation of the control table 100.

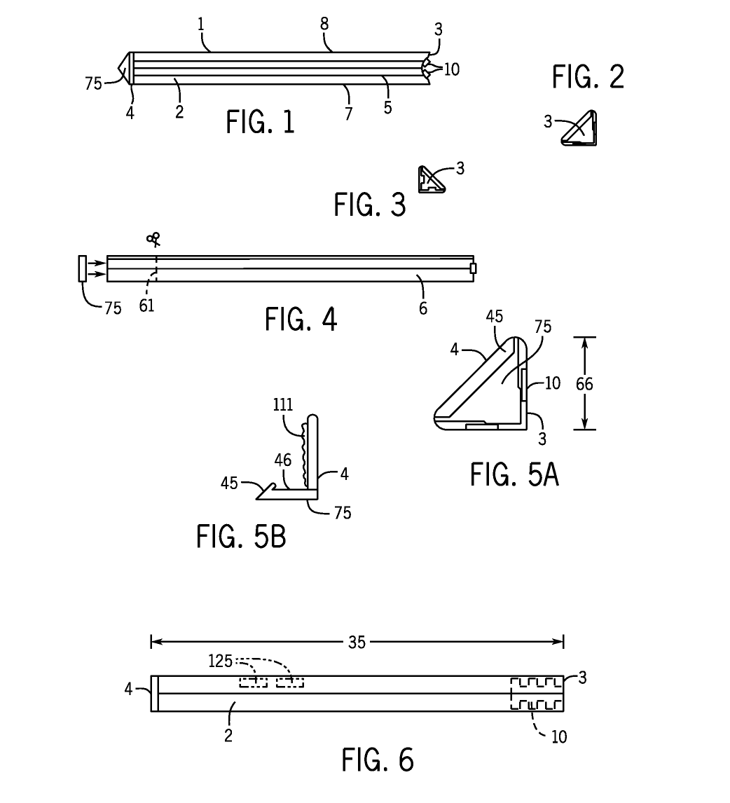

Referring now to FIGS. 1-6, in an embodiment, the corner guard 1 may have a main body portion 2 and at least one tab portion 10. The main body portion 2 may have a top 3, a bottom 4, a front 5, a back 6 (FIG. 4), a first side 7 and a second side 8. The tab portion 10 may have a top 11 (FIG. 10), a bottom 12, a front 13, a back 14, a first side 15 and a second side 16. Preferably, two tab portions 10 are secured to the top 3 of the main body portion 2, one on the first side 7 and one on the second side 8; however, alternative embodiments may have one tab 10 or more than two tabs 10.

In an embodiment, the tab portion 10 is made from, for example, eighteen gauge spring steel, so as to provide proper tension on the body portion 2 while the device 1 is secured to the control table 100 (or “tool box”). The tab portion 10 may be partially secured within the body portion 2 (FIG. 6). In an embodiment, the tab portion 10 has a length 40 (FIG. 9A). The length 40 of the tab portion 10 may be great enough so that the tab portion 10 remains partially secured with in the interior of the main body section 2. In an embodiment, the main body section 2 may have a length 35 (FIG. 6). In an embodiment, the length 40 of the tab portion 10 is approximately five to twenty percent the length 35 of the main body section 2 so as to be long enough to provide support to the main body section 2 while not being too long so as to prevent the main body section 2 from slightly being able to be bent during installation and removal of the device 1 from the control table 100. In an embodiment, the length 35 of the main body section 2 may be altered by cutting (FIG. 4) a portion of the bottom 4 of the main body section 2 so as the device 1 may be used on a control table 100 having a smaller edge.

In an alternative embodiment, a perforation line 61 may be located near the bottom 4 of the main body section 2. The perforation line 61 may be located at a distance from the top 3 of the main body section 2 which corresponds to, for example, a common length 63 (FIG. 12) of a control table 100. As a result, a user may alter the overall length 35 of the main body section 2 by cutting the main body section 2 at, for example, the perforation line 61 and then reattaching a generally triangular cap 75 (FIG. 4) located at the bottom 4 of the main body section 2. The perforation line 61 may further allow a user to remove a portion of the bottom 4 of the main body 2 without the need for a saw or scissors. It should also be understood that the bottom 4 of the main body section 2 may also lack the preformation line 61 so as to increase stability of the device 1. In the embodiment wherein the preformation line 61 is not present, a user may use a standard table saw to cut the bottom 4 of the main body section 2 and then may reapply the generally triangular cap 75.

Referring now to FIGS. 5A and 5B, in an embodiment, the removable triangular cap 75 may have an elevated ledge portion 45. The elevated ledge portion 45 may extend above a generally flat main body portion 46 of the removable triangular cap 75. The elevated ledge portion 45 may grasp the bottom of the control table or tool box 100 and may prevent the device 1 from slipping off the control table or tool box 100. Preferably, the elevated ledge 45 is angled inward at approximately forty-five degrees so as to better grasp the bottom of the control table or tool box 100.

Referring now to FIGS. 8-11, the tab portion 10 may have a head portion 23 and a skeleton portion 24. The head portion 23 may have a back 81, a top 82 and a front 83. The back 81 may be generally square-shaped and generally flat. The front 83 may be generally rectangular and generally flat. The back 81 and the front 83 may be largely parallel with respect to one another. The front 81 and the back 83 may be both connected to the top 82 portion; wherein the top 82 is substantially perpendicular with respect to the back 81 and the front 83. A distance 60 may separate the back 81 from the front 83. In an embodiment, the tab portion 10 is generally rigid so that the distance 60 between the back 81 and the front 83 remains largely constant.

Attached the back 81 of the tab portion 10 may be the skeleton portion 24. The skeleton portion 24 may have a plurality of extensions 50 extending out from a main shaft. FIGS. 8-11 illustrate eight extensions 50 extending from the main shaft; however, any number of extensions 50 may be used. In an embodiment, each extension 50 may have a top, a first side and a second side. The first side and the second side may be slightly slanted 95 downward. Further, in an embodiment, each extension 50 is substantially similar in size and shape. The extensions 50 may provide additional surface area to secure the tab portion 10 within the main body 2 of the device.

In an embodiment, the back 81 of the tab portion 10 may have a plurality of openings 80 (FIG. 11). The openings 80 may receive an already formed protrusion (not illustrated) located within the interior of the main body portion 2 of the device 1 or the openings 80 may be inserted into the main body portion 2 while the main body portion 2 is being constructed so that melted plastic, rubber or the like of the main body section 2 fills in the openings 80 of the tab portion 10. As a result, the openings 80 allow the tab portion 10 to be further secured partially within the main body portion 2.

As stated above, in an embodiment, the skeleton portion 24 of the tab portion 10 may be concealed and may be located partially within the main body portion 2. More specifically, the skeleton portion 24 of the tab portion 10 may be partially located within the top 3 of the main body section 2 while the head portion (81, 82, 83) of the tab portion 10 extends beyond the top 3 of the main body section 2 and are visible.

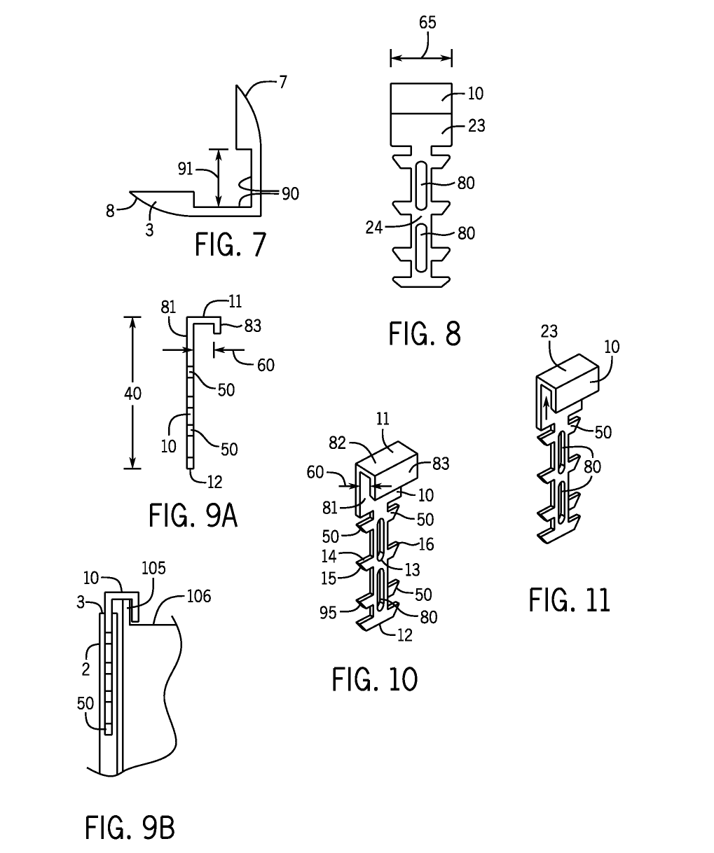

The top 3 of the main body section 2 may have a plurality of indentations 90 (FIG. 7). FIG. 7 illustrates two indentations 90 (one on the first side 7 and one on the second side 8 of the main body section 2). The indentations 90 may have a length 91 which is substantially equal to a length 65 (FIG. 8) of the head 23 of the tab portion 10 such that the head 23 of the tab portion 10 snugly fits partially within the indentation 90. Further, the length 65 of the head 23 of the tab portion 10 is approximately one-third the in overall length 66 (FIG. 5A) of a side of the top 3 of the main body 2 so as to better stabilize the tab portion 10 within the top 3 of the main body 2. Still further, in an embodiment, the head 23 of the tab portion 10 is secured in the center of the sides of the top 3 of the main body 2 to better stabilize the tab portion 10.

As stated above, the bottom 4 of the main body portion 2 may have a generally triangular cap 75. The generally triangular cap 75 may not only be more esthetically pleasing than an uncapped bottom 4 of the main body 2, but the generally triangular cap 75 may provide further support to the device 1 and may further partially secure the first side 7 of the device 1 to the second side 8 of the device 1. Still further, the generally triangular cap 75 may partially cover a sharp edge of the control table 100.

To use the device 1, a user may first align the bottom 4 of the main body section 2 to the bottom corner 101 (FIG. 12) of the control table 100. The generally triangular cap 75 may then be snapped into place (if not already secured to the bottom 4) at the bottom 4 of the main body section 2 so that the entire corner of the control table 100 is covered and protected. A user then aligns the main body 2 of the device 1 with the corner of the control table 100. The user then secures the front 83 of the head 23 of the tab portion 10 over a ridge 105 at the top 106 of the control table 100. As illustrated in FIG. 9A, the ridge 105 of the control table 100 may be placed partially within the space 60 between the back 81 and the front 83 of the head 23 of the tab portion 10. The device 1 may be secured onto the corner of the control table 100 by, for example, gravity or friction created by the head 23 of the tab portion 10. To remove device 1 from the control table 100 the reverse process is performed.

In alternative embodiments, the tab portion 10 and/or the main body portion 2 may be entirely or partially magnetic (having internal magnets 125) so as to be attracted to the control table 100. This further secures the device 1 to the control table 100. An adhesive (not shown) may also be used to further secure the device 1 to a control table 100. In yet another alternative embodiment, the tab portions 10 are magnetic and attracted to the corners of the control tables or tool boxes 100 and secures the corner guards 1 to the control table or tool box 100.

Finally, in an alternative embodiment, a removable hook 136 (FIG. 12) may be located on the exterior surface of the main body 2. The removable hook 136 is preferably located near the top 3 of the main body 2. The removable hook 136 allows a user to hang, for example, keys to open the control table or tool box 100, clothing, etc. As a result, by adding the corner guard 1 to a control table or tool box 100, a user may therein secure a storage hook to the corner of the control table or tool box 100 without damaging the control table or tool box 100. Of course, the device 1 may be utilized without the removable hook 136 by unscrewing the removable hook 136 from the inside surface of the device 1 or the device 1 may be sold without the removable hook 136.

Although embodiments of the invention are shown and described therein, it should be understood that various changes and modifications to the presently preferred embodiments will be apparent to those skilled in the art. Such changes and modifications may be made without departing from the spirit and scope of the invention and without diminishing its attendant advantages.

We claim:

1. A removable corner guard for a control table or tool box comprising:
a generally elongated body having a top, a bottom, a front, a back, a first side, a second side wherein the generally elongated body has an L-shaped cross section and has a length;
an interior opening located at the top of the generally elongated body;
a generally triangular cap unit removably secured to the bottom of the generally elongated body;
a first tab secured to the top of the generally elongated body the first tab having a front, a back, a first side, a second side, a top and a bottom wherein a plurality of extended arm portions extends out from the first side and the second side of the first tab and wherein the extended arm portions of the first tab are secured within the interior opening of the top of the generally elongated body; and
wherein the first tab is secured to the top of a control table or tool box and prevents the removable corner guard from moving with respect to the control table or tool box.

2. The removable corner guard for a control table or tool box of claim 1 further comprising:
a perforation line located at the bottom of the generally elongated body wherein the perforation line allows a user to alter the length of the generally elongated body.

3. The removable corner guard for a control table or tool box of claim 1 wherein the first tab is metal.

4. The removable corner guard for a control table or tool box of claim 3 wherein the first tab is an eighteen gauge spring-steel tab.

5. The removable corner guard for a control table or tool box of claim 1 further comprising:
a removable cap secured to the bottom of the generally elongated body wherein the removable cap grasps a portion of a bottom of the control table or tool box and secures the generally elongated body to the control table or tool box.

6. The removable corner guard for a control table or tool box of claim 1 wherein the first tab is secured to a top of a control table or tool box by gravity.

7. The removable corner guard for a control table or tool box of claim 1 wherein the first tab is magnetic and secures the corner guard to the control table or tool box.

8. The removable corner guard for a control table or tool box of claim 1 wherein an exterior surface of the elongated body has a glow-in-the-dark or fluorescent marking.

9. The removable corner guard for a control table or tool box of claim 1 further comprising:
a removable hook secured to the first side or the second side of the generally elongated body wherein the removable hook allows a user to hang keys, clothing and other personal items on the corner guard.
